(19) United States
(12) Patent Application Publication
(10) Pub. No.: US 2017/0246778 A1
(43) Pub. Date: Aug. 31, 2017

(54) APPLYING RFID TAGS TO TUBULAR COMPONENTS BY INJECTION MOLDING

(71) Applicant: Falcon Engineering Limited, Inglewood (NZ)

(72) Inventor: Gregory Douglas Trowbridge, Lepperton (NZ)

(21) Appl. No.: 15/321,123

(22) PCT Filed: Oct. 26, 2015
(86) PCT No.: PCT/IB2015/058250

§ 371 Date: Dec. 21, 2016

Related U.S. Application Data
(60) Provisional application No. 62/068,819, filed on Oct. 27, 2014.
(60) Provisional application No. 62/083,565, filed on Nov. 24, 2014.

(51) Int. Cl. B29C 45/14; E21B 41/00; E21B 17/10

(52) U.S. Cl. CPC B29C 45/14065; B29C 45/14819; B29C 45/14598; E21B 17/1078; E21B 41/00; B29C 2045/14114; B29C 2045/14852; E21B 47/00

(57) ABSTRACT

An apparatus including a sleeve and a tag embedded into the sleeve by injection molding. The sleeve may include an outer wear resistant surface. The surface comprising a plurality of integral grooves traversing angularly along the surface. The sleeve may include a wear cage. The wear cage may include two rigid fiber reinforced polymer symmetrical halves, couplable to each other, wherein each symmetrical halve may include, an inner surface, a channel integral along the full circumferential length of the inner surface, an outer surface, and a plurality of annular elements separated by stand-offs.

### CROSS-REFERENCE TO RELATED APPLICATIONS

This application claims the benefit of U.S. Provisional Application No. 62/083,565, filed Nov. 24, 2014 which is incorporated by reference. This application claims the benefit of U.S. Provisional Application No. 62/068,819, filed on Oct. 27, 2014, which is incorporated by reference.

### BACKGROUND

Radio-frequency identification (RFID) is the use of a wireless non-contact device that uses radio-frequency electromagnetic fields to transfer data from an RFID tag attached to an object, for the purposes of automatic identification and or tracking. Some RFID tags require no battery and are powered by the electromagnetic fields used to read them. Others use a local power source and emit radio waves, which can be read from up to several feet away. Unlike a bar code, the RFID tag may be embedded in the tracked object or otherwise obscured.

RFID tags are used in many industries. For example, in the oil and gas industry, RFID tags are used to track assets used in downhole operations. However, conventional RFID tags and tracking methods were not designed for operation in harsh subterranean environments. Additionally, some downhole tubular assets used in downhole operations may not be suitable for integration with certain RFID tags. These tubular assets may not have the suitable thickness, proper dimensions, or a large enough cross-sectional area for receiving an RFID tag suitable for subterranean environments.

The use of RFID tags on tubular components used in drilling, pipeline, and hydraulic fracturing applications for asset tracking and or asset management is recent technology. Currently, the method for applying the RFID tags involves compromising the tubular's mechanical properties because the RFID tags are embedded into the metal tubular body and or its mating components. Embedding the RFID tag into downhole tubular is not a preferred methodology, because of the potential to create stress risers at the area of application. The present disclosure describes a process that does not embed or compromise the tubular while still protecting the RFID tag and allowing for tracking and managing tubular assets.

Typically, in the drilling of oil and gas wells, a drill bit is attached to the bottom of a drill string and the drill string and drill bit are rotated from the surface causing the drill bit to bore through the underground formations. A drill string typically comprises a series of connected tubular drill pipes running from the surface down to the drill bit at the bottom of the string. To construct the well, steel casing is typically installed to line the walls of the wellbore at various drilling depths. The casing lines the wellbore to prevent the wall of the wellbore from caving in and to prevent seepage of fluids from the surrounding formations from entering the wellbore.

During drilling, the drill string rotates in the wellbore, and as the drill string is relatively flexible, the application of weight onto the drill string or resistance from the drill bit can cause forces to be exerted on the drill string causing it to deflect within the wellbore. In addition, the drilling of some wells require the well to have deviated sections where the wellbore runs along at an angled or curved path resulting in potential contact of the drill string with the casing or wellbore. These deflections or deviated wells can result in portions of the drill string rubbing against the casing or wall of the wellbore as the bit is rotated from the surface. The drill string is subjected to increased shock and abrasion whenever the drill string comes into contact with the wall of the wellbore or, where lined, the casing.

To alleviate these problems, drill pipe protectors are placed in different locations along the length of the drill string to keep the drill pipe and its connections away from the walls of the casing and/or formation. These drill pipe protectors were originally made from sleeves of rubber or other elastomeric material and the outside diameter of the protectors is sized to be slightly bigger than the overall outside diameter of the tool joint connection where the one drill pipe fits into the next.

Rubber or other elastomeric materials were used because of their ability to absorb shock and impart minimal wear. These drill pipe protectors rotate with the drill pipe and are attached to the tubular drill pipe typically by clamping together around the pipe and securing with steel or alloy bolts.

When in an open hole, the abrasive nature of the formation on drill pipe protectors made from these traditional materials can result in excessive and premature wear. Additionally, this potentially creates increase drag resulting in increased torque required to drive the drill string.

These protectors typically require some assembly as their design may be hinged or in 2 pieces. These units need to be placed over the drill pipe and assembled with various pins and/or metal ties and clamped rigidly in position with bolts. Additionally, these designs need to cater for any variances in the outside diameter of the drill pipe and as a result the ability to achieve sufficient radial clamping force to prevent slippage can be compromised. When the drill pipe protector slips from its original position the drill pipe is exposed to wear, resulting in a reduction in its useful life.

Ideally, downhole drill components should remain integral in use and any drill debris (i.e., parts which detach in use due to wear) should be drillable. This means that any pieces which break off the drill string should be able to be broken down by the drill bit and returned to the surface along with the cuttings and drilling fluid. The use of steel bolts and pins presents a disadvantage in these traditional drill pipe protectors.

It is preferable that the lower sections of the drill string which rotate in the open hole are fitted with protective devices which will remain stationary while the drill string rotates.

### BRIEF DESCRIPTION OF THE DRAWINGS

FIG. 1 is a perspective view of an RFID tubular sleeve.

FIG. 2 is a perspective view of a cross-sectional profile of an RFID tubular sleeve.

FIG. 3 is a perspective view of an over-all assembly of a plurality of RFID tubular sleeves on a downhole tubular.

FIG. 4 is a perspective view of an RFID tubular sleeve for a tubular.

FIG. 5 is a perspective view of an RFID tubular sleeve on a tubular assembly.

FIG. 6 is a perspective view of an RFID tubular sleeve for transportation pipeline.

FIG. 7 is a perspective view of an RFID tubular sleeve on transportation pipeline assembly.

FIG. 8 a cut-away view of a reinforced wear resisting cage positioned on a tubular encapsulated with the outer polymer.

FIG. 9A is a side view of the of the wear resisting cage.

FIG. 9B is a top view of the wear resisting cage showing the two halves of the wear resisting cage.

FIG. 9C is a perspective view of the two halves of the wear resisting cage.

FIG. 10 is a side view of a drill pipe protector showing the drill pipe with the molded cylindrical inner sleeve with integral stop collars together with the outer sleeve.

FIG. 11 is a side sectional view of the drill pipe protector showing the clearance between the inner and outer sleeve.

FIG. 12 is a close up sectional view showing the layer of soluble sheet material between the inner and outer sleeve.

FIG. 13 is an end view of the drill pipe protector.

FIG. 14 is a three-dimensional rendered view of the of the drill pipe protector on a drill pipe showing the inner sleeve with integral stop collars and the outer sleeve with raised ridges and holes.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

### Radio Frequency Identification on Tubular Assets

A radio frequency identification (RFID) tag is applied to tubular components used in drilling, pipeline, and hydraulic fracturing applications without compromising the tubular while still protecting the RFID tag in downhole or surface environments. The process may include applying an RFID tag to the tubular and protecting the tag through the method of injection molding around the RFID tag and the downhole tubular. In one or more embodiments, the molding uses a fiber reinforced polymer material, with or without integrally formed grooves running helically along its length. The fiber reinforced polymer is applied over the complete outer surface of the tubular bonding through interference-fit, thus protecting the RFID tag in downhole environments.

In one or more embodiments, a tubular sleeve may include helical integral formed grooves on the injection molding from a fiber reinforced polymer material onto the downhole tubular. Once the cylindrical body is formed, a polyurea high performance coating is separately applied to cover the full external surface of the cylindrical body forming a continuous bonded shell of a specific thickness. This outer layer is integrally bonded with the surface of the cylindrical body. This outer layer produces extended service life of the downhole tubular sleeve by preventing wear and damage to the base material.

The outer layer can be repaired by re-spraying and building up the worn surface of the cylindrical body with a layer of polymer spray, thereby further extending the life of the downhole tubular sleeve.

The external polymer coating may be applied using a thermal spray process, which may include a multi-part polyurethane base of 100% solids and 100% polyurea. The external layer is harder than the cylindrical body's base material and provides the abrasion wear resistance surface that comes into contact with the casing or well formation.

In one or more embodiments, a solid particle material may be applied to and embedded in the external polymer surface during or following the polymer spray application. The solid embedded particles aid in providing further abrasion wear resistance. This solid embedded particle may include tungsten carbide in the range of 2 to 3 millimeters (mm) in diameter and spherical in shape. The solid embedded particle may include other materials with similar properties. The solid embedded particle's size and shape may vary to suit the application.

The external diameter of the downhole tubular sleeve is slightly bigger in diameter to the downhole tubular tool joint diameter, thereby reducing the contact force acting between the tool joint and the wall of the casing or well formation. The pre-formed inner body is slightly less than the finished diameter of the downhole tubular sleeve to allow for the thickness of the external spray wear resistant layer.

If desired, the tubular sleeve can be applied to any position along the length of the downhole tubular either singularly or in multiples.

In the case of a failure of the sleeve down hole, the sleeve is fully drillable and any debris that may break off will be broken down hole and returned to the surface with the cuttings.

The tubular sleeve may be formed from a polymer, preferably a polyamide, or similar type with glass, carbon or aramid fiber as reinforcing.

The plurality of integral formed grooves extending the length of the cylindrical body running in an angular direction to the axis allows the flow of drilling fluid.

In one or more embodiments, one or more RFID tags can be incorporated by embedding the RFID tag(s) into the polymer during the injection molding process. The downhole tubular can have a unique identification and associated data written to the RFID tag. The RFID tag, when read, allows for full tracking and traceability at any desired location.

In one or embodiments, the tubular sleeve may be smaller in external diameter than the tool joint. This embodiment enables the protection of any embedded instrumentation or RFID tags from abrasion or wear downhole.

In one or more embodiments, an RFID tag is placed on a tubular. The RFID tag is then wrapped with urethane impregnated fiberglass tape activated by water. The urethane impregnated fiberglass tape is applied wet and wrapped around the tubular where the RFID tag is located. As it dries, the urethane impregnated fiberglass tape hardens to form a protective coating around the RFID tag.

In one or more embodiments, an RFID tag may be replaced with or used in conjunction with small self-contained sensor device. The self-contained sensor device may either be electronic, mechanical, or a combination thereof, to log downhole data. The self-contained sensor device may include, but not limited to, the measurement of acceleration, strain, temperature and GPS location data. The logged data and the self-contained sensor device's power may be transferred from the self-contained sensor device by wireless means, or by physically removing the sensor device from the polymer encapsulation and extracting the data.

In one or more embodiments, the self-contained sensor assembly may be battery powered. This battery may be charged by a non-contact method, preferably induction charging

This disclosure also describes an improvement to the wear sleeve designs for drilling tubular which are of a molded or cast type.

Existing wear sleeve designs may fall into two types. Those (1) that are fixed to the drilling tubular and rotate with the drilling tubular, and (2) the other where an inner sleeve remains fixed and the outer sleeve rotates on the outer surface of the fixed sleeve. The wear sleeve described herein improves on the traditional molded fixed wear sleeve.

Traditional molded wear sleeves formed from a single polymer, rubber or resin have a tendency to wear quickly due to their low abrasion resistance, in particular under high loads.

The present disclosure relates to combining RFID tags suitable for use in subterranean and/or surface environments with assets used in well construction, permanent and temporary surface pipelines, and hydraulic fracturing operations. Some assets used in these operations may not be readily suitable for integration with certain RFID tags in a manner suitable for use in these environments. Such assets may not have the proper thickness, proper dimensions, or a large enough cross-section for receiving an RFID tag suitable for the above-mentioned environments.

More particularly, the present disclosure relates to an improved system and method for integrating an RFID tag suitable for subterranean and/or surface environments with assets used in downhole drilling, pipeline, and hydraulic fracturing operations.

Integrating RFID tags suitable for subterranean environments with assets used in downhole drilling, pipeline, and hydraulic fracturing operations in the manner disclosed herein may also allow for the tracking of assets in subterranean formations under conditions where conventional RFID tags would fail and/or in conditions where a tool is not readily configurable to receive an RFID tag in a manner suitable for downhole environments.

Integrated RFID tags may also provide unique electronic identification of assets. This method allows for the elimination of asset stenciling. In one or embodiments, using electronic identification allows tracking of multiple assets in harsh conditions and environments, eliminates data entry or hand writing processes, and improves the efficiency of maintenance, inspection, and business processes. As a result, this method provides cost effective and long lasting solutions to tracking needs, and eliminates the need for maintenance on the RFID tags.

In one or more embodiments, an RFID tubular sleeve assembly may include an RFID tag, a sleeve, and a tubular body. In one or more embodiments, the RFID tag is mounted onto the tubular body through the method of injection molding around the RFID tag and the tubular body. In one or more embodiments, an RFID tag is placed on a tubular body. The RFID tag may include a light adhesive on the surface of the RFID tag that is in contact with the tubular body. In one or more embodiments, this adhesive keeps the RFID tag attached to the tubular body as the tubular body is placed on a rack and fed through the injection molder. In one or more embodiments, the tubular body is positioned so that the injection molder will encircle the tubular body where the RFID tag is located. In one or more embodiments, the injection molder closes around the tubular body where the RFID tag is positioned. In one or more embodiments, a polymer is then injected into the mold which forms around the tubular body where the RFID tag is positioned. In one or more embodiments, the polymer is allowed to cool and cure on the tubular body where the RFID tag is positioned resulting in a sleeve with an RFID tag.

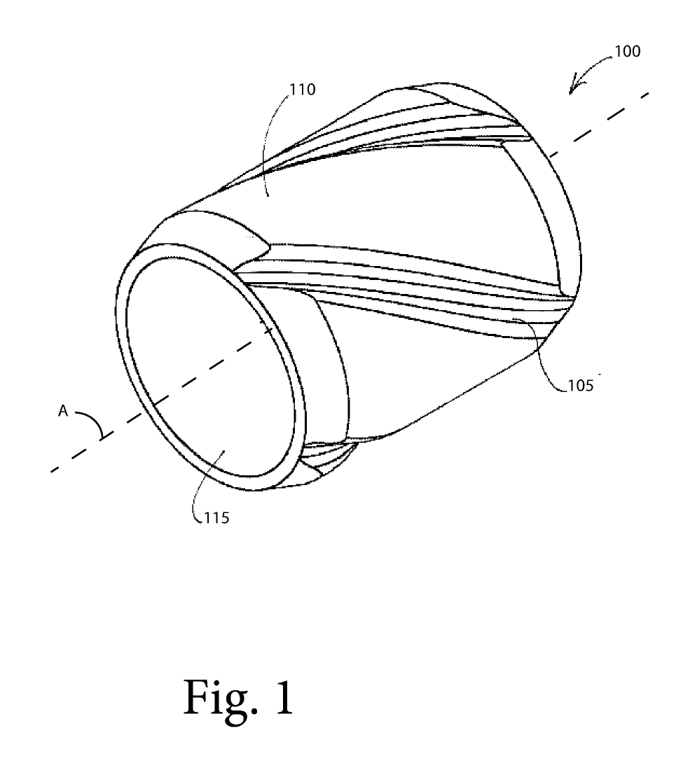

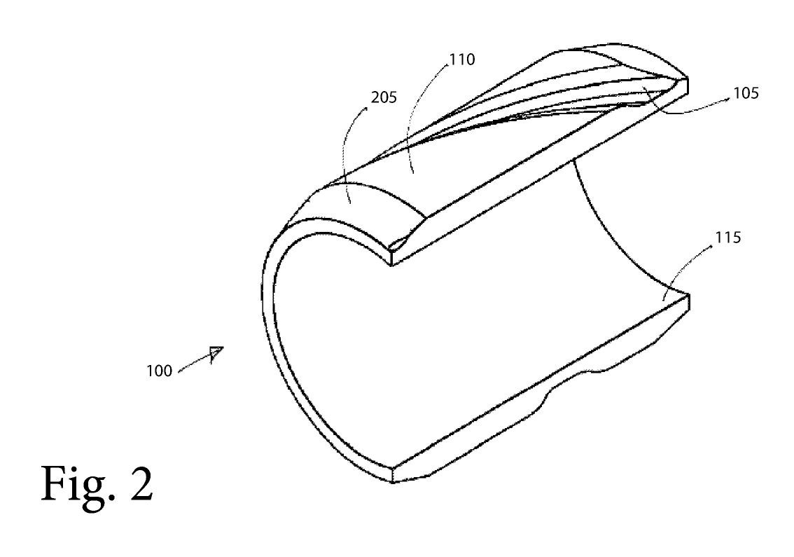

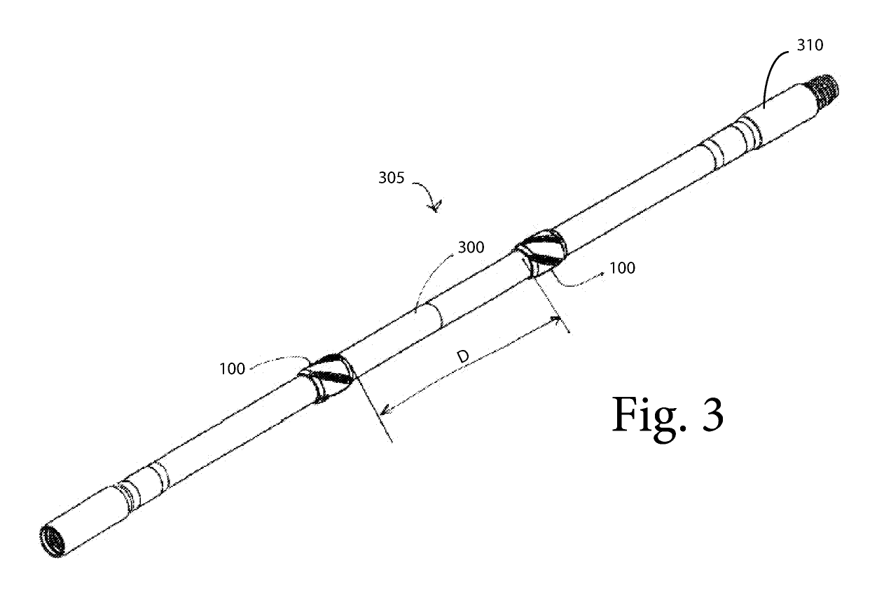

Referring initially to FIG. 1, a perspective view of an RFID tubular sleeve 100 is illustrated. The RFID tubular sleeve 100 may include a number of helical grooves 105 formed on an outside surface 110 of the tubular sleeve 100. As shown in FIG. 1, the grooves 105 may run helically along the length of tubular sleeve 100. In one or more embodiments, the helical grooves 105 may include a depth that is less than the thickness of the RFID tubular sleeve 100 (discussed below in connection with FIG. 2). The inside surface 115 may be the same diameter of the tubular body 300 as shown in FIG. 3, discussed below.

FIG. 2 is a perspective view of a cross-sectional profile of the RFID tubular sleeve 100 along the dotted line “A” of FIG. 1. In accordance with certain embodiments, the RFID tubular sleeve 100 may include an 18 degree beveled end section 205 with an inside diameter (determined by inside surface 115) and an outside diameter determined by outside surface 110.

FIG. 3 is a perspective view of an RFID tubular sleeve assembly showing two RFID tubular sleeves 100 connected to a tubular body 300 which all are joined to make up a drilling tubular 305. In one or more embodiments, the RFID tubular sleeve 100 may be applied in more than one section of the tubular body 300. As shown in FIG. 3, a plurality of RFID tubular sleeves 100 may be applied to the tubular body 300 at specified distances (as indicated by distance “D”) from one another; to maximize the efficiency of minimizing tubular body 300 contact with the open or cased hole of the drilled well (not shown).

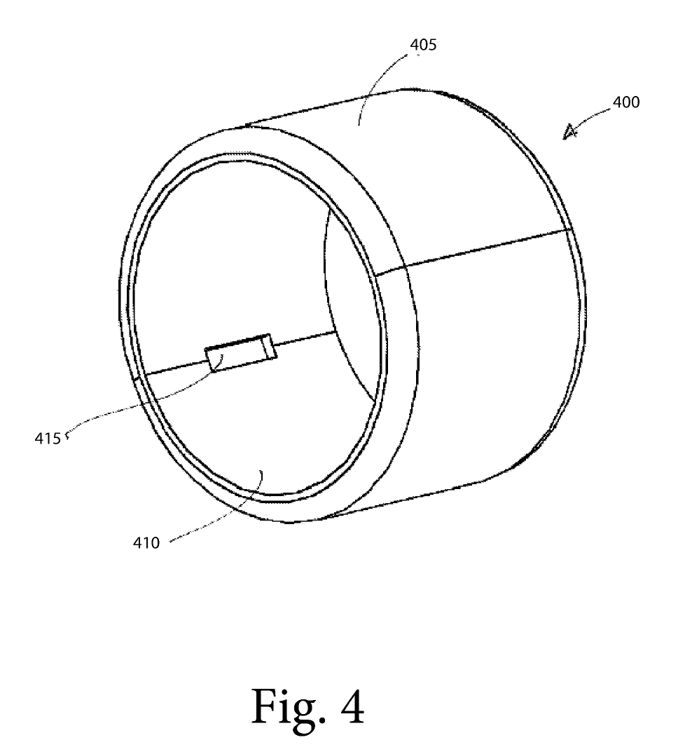

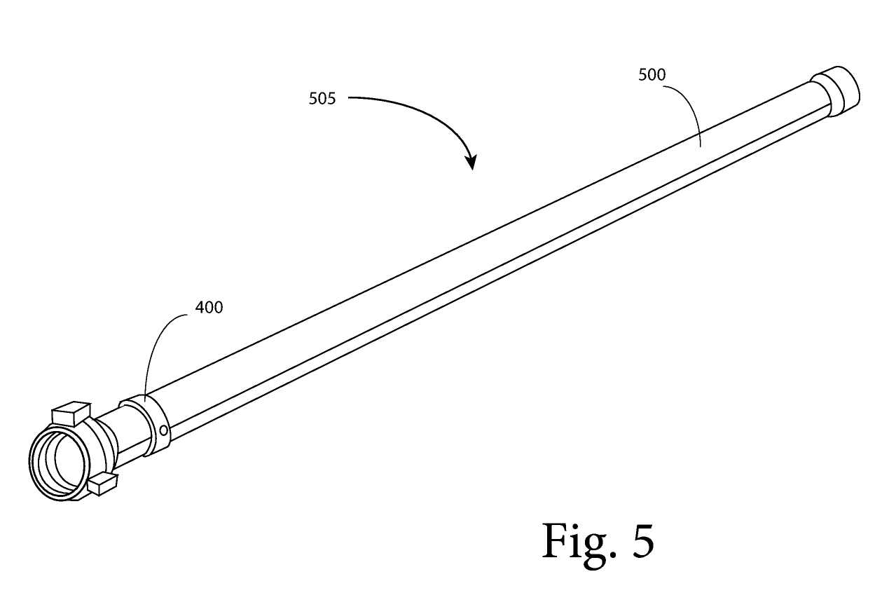

FIG. 4 is a perspective view of an RFID tubular sleeve 400 for a tubular body. The RFID tubular sleeve 400 may have an outside surface 405 and an inside surface 410. In one or more embodiments, the outside surface 405 is cylindrical and may or may not have integrally formed grooves that run helically along its length. In one or more embodiments, the inside surface 410 has the same diameter as the outside diameter of the tubular body 500, (such as tubular body 500 described below in connection with FIG. 5). In one or more embodiments, the tubular sleeve 400 may have an RFID tag 415 (shown in FIG. 4) embedded within the inside surface 410 of the RFID tubular sleeve 400 through the method of injection molding.

FIG. 5 is a perspective view of an RFID tubular sleeve 400 connected to a tubular body 500 which all are joined to make up a tubular 505.

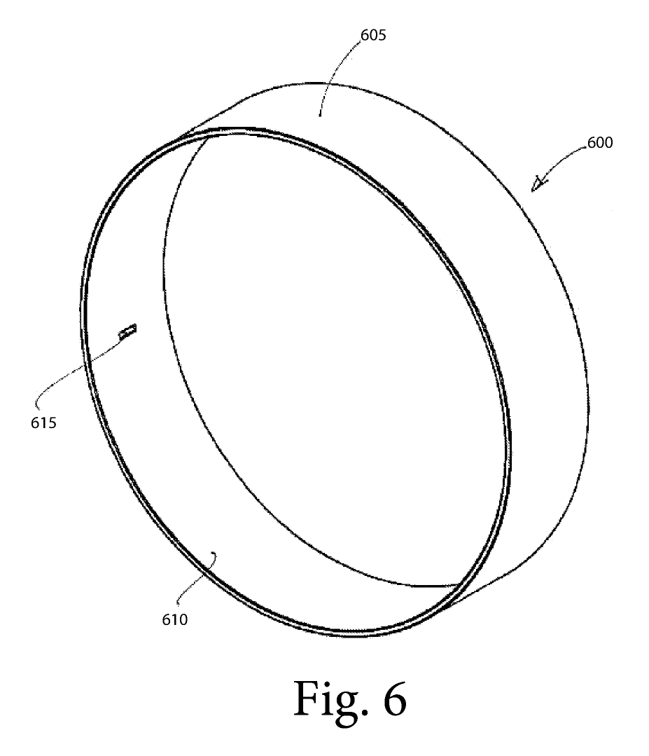

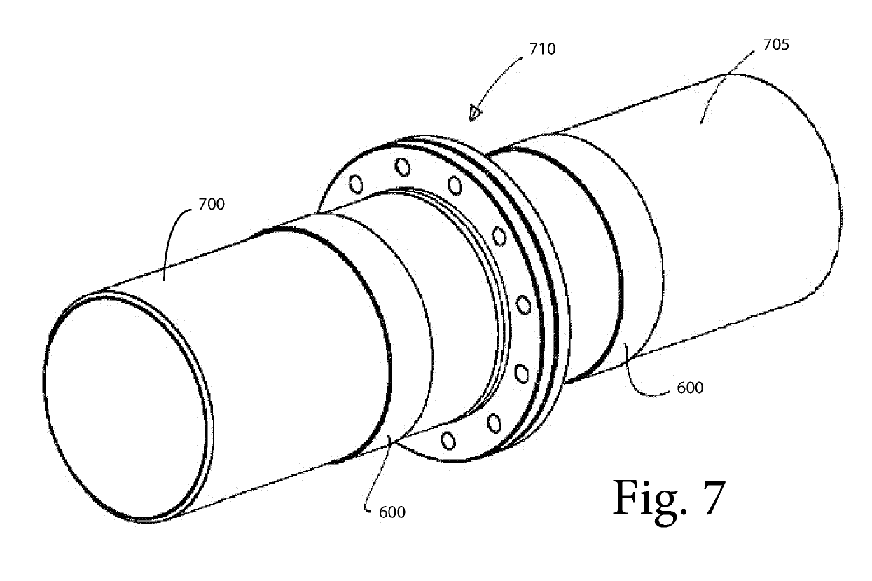

FIG. 6 is a perspective view of a RFID tubular sleeve 600 for use in a transportation pipeline. In one or more embodiments, the tubular sleeve 600 has an outside surface 605 and an inside surface 610. In one or more embodiments, the outside surface 605 is cylindrical and may or may not have integrally formed grooves that run helically along its length. In one or more embodiments, the inside surface 610 may be the same diameter as the outside diameter of a tubular body 700 (such as tubular body 700 described in connection with FIG. 7). Also, the tubular sleeve 600 has an RFID tag 615 embedded within the inside surface 610 through the method of injection molding.

FIG. 7 is a perspective view of RFID tubular sleeves 600 on a transportation pipeline assembly showing the RFID tubular sleeves 600 connected to tubular bodies 700 and 705 which all are joined to make up a pipeline tubular 710.

This disclosure describes a molded cylindrical body encapsulating an inner reinforced wear resisting cage with improved wear resistance.

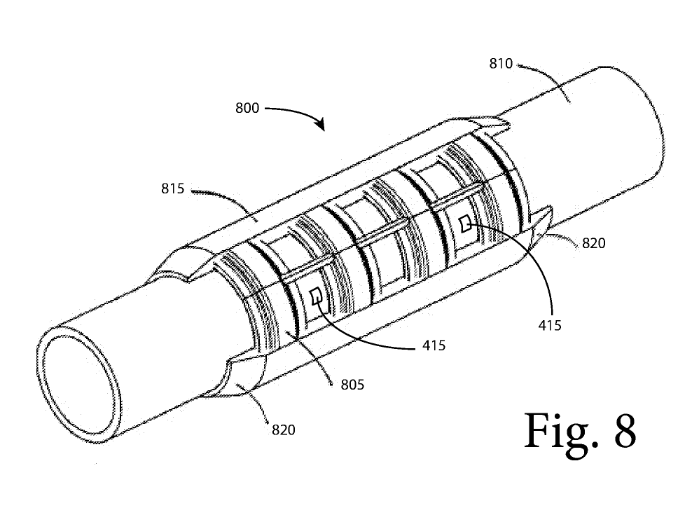

Referring to FIG. 8, a cut-away view of a reinforced wear resisting cage 800 is illustrated. In one or more embodiments, the reinforced wear cage 800 may include an internal rigid polymer wear resisting cage 805 placed at a selected location on a tubular body 810. In one or more embodiments, the tubular body 810 is over molded with a reinforced polymer material forming a cylindrical unitary body 815 with tapers 820 at either end. The RFID tag 415 may be coupled to a tubular (such as tubular body 300, tubular body 500, or tubular body 700). One or more RFID tags 415 may be placed on a tubular (such as tubular body 300, tubular body 500, or tubular body 700). The wear cage 800 may be positioned over the RFID tag 415 and over molded with the reinforced polymer material forming the cylindrical unitary body 815. A plurality of wear cages 800 may be placed on a tubular (such as tubular body 300, tubular body 500, or tubular body 700).

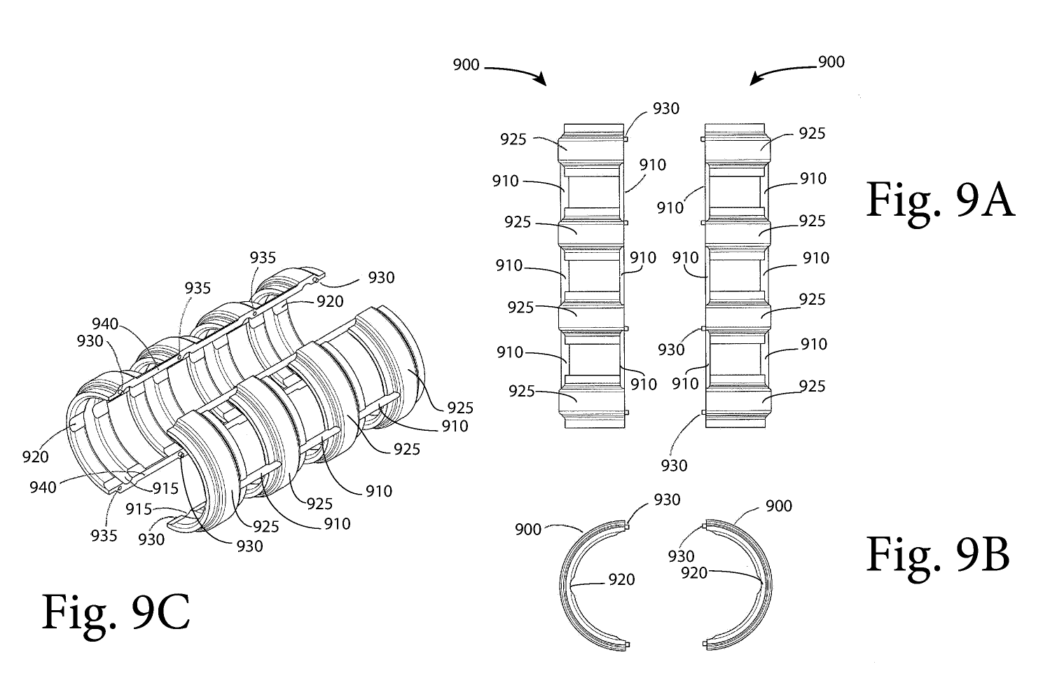

FIG. 9A is an side view of the wear resisting cage 800 showing two identical halves 900.

In one or more embodiments, the wear resisting cage halves 900 may be formed by injection molding using a polyamide polymer containing glass fiber reinforcing. In one or more embodiments, the polyamide polymer may comprise Polyamide 66 with 65% long glass fiber reinforcing. The proportion of glass fiber reinforcing and the length of the glass fiber may be adjusted to suit the application. For example, decreasing the proportion of glass fiber may reduce the strength, stiffness and abrasion resistance. In applications where a lower level of performance is required, the amount of the glass fiber may be reduced. Increased fiber length may improve the impact resistance and rigidity of the wear resisting cage halves 900

In one or more embodiments, the wear resisting cage halves 900 may be produced from any polymer and the reinforcing may be any of carbon fiber or mineral.

The physical properties of the internal rigid polymer wear resisting cage assembly 805 are such that the hardness and impact resistance is greater than that of the polymer material of the unitary body 815 encapsulating the internal rigid polymer wear resisting cage assembly 805.

The unitary body 815, in one or more embodiments, is a cylindrical body with a diameter equal to or greater than that of the outer diameter of the tubular tool joint 310. The ends of the cylindrical body are tapered 820 towards the body of the tubular body 810.

In one or more embodiments, the material of the unitary body 815 may be Polyamide 6 with 30% glass fiber reinforcing. Other polymer materials may be used. The proportion of glass reinforcing may vary depending on the wear properties required in the application. In one or more embodiments, the reinforcing may be carbon fiber or other mineral.

The internal diameter of the assembled cage is such that when assembled it fits over the external diameter of the tubular body 810.

This internal reinforced polymer wear resisting cage 805 may include symmetrical halves 900 which are placed over the circumferential outer surface of tubular body 810 and interlock together to form the reinforced wear resisting cage 805.

As illustrated in FIGS. 9A-9C, each wear resisting cage half 900 has two or more recessed cylindrical holes 935 pre-molded into each face 940 of the wear resisting cage half 900 such that when each symmetrical wear resisting cage half 900 is placed together the holes 935 on the opposing faces are directly in alignment. In one or more embodiments, a dowel 930 comprising a short cylindrical section of plastic, separately molded, is inserted into the recessed cylindrical hole 935 and retained in place with an interference fit such that sufficient length protrudes from the face 940 so that it will align and insert into the recessed hole 935 on the opposing face. One or more dowels 930 are used on each upper and lower face 940 such that when the two wear resisting cage halves 900 are assembled and mated together, the dowels 930 allow the two symmetrical halves 900 to interlock together to form the reinforced wear resisting cage 805.

Each wear resisting cage half 900 may include annular elements 925 separated by stand-offs 910. The number of annular elements 925 may be two or more.

Each annular element 925 has an integral channel 915 along the full length of its inner surface opening out to its end section. Through the mid-point along the inner surface of the annular element 925, a channel 920 runs out perpendicular to the integral channel 915 and opens out to each side. The purpose of the integral channel 915 and the channel 920 is to allow the flow of polymer material during the over molding process. The melted polymer material when injected under high pressure will flow around the outer surface of the cage assembly 805 and through the channel 915 and the channel 920. Once the polymer solidifies, the cage assembly 805 is fully encapsulated with the outer over molded unitary body 815 forming a unitary body.

The method of forming the reinforced wear sleeve (such as RFID sleeve 100, tubular sleeve 400, and tubular sleeve 600) is to place two wear resisting cage halves 900 at a predetermined position along the length of the tubular body 810 and assemble them together with the use of dowels 930 as mentioned above. In one embodiment, the prepared tubular body 810 with reinforced polymer cage located in position around its external circumference is placed into a two piece mold within a conventional injection molding machine. The mold is closed around the section with the internal rigid polymer wear resisting cage 805 such that the outer surface of the internal rigid polymer wear resisting cage 805 has equal clearance from the inner surface of the closed mold. The internal mold cavity is shaped in the same three-dimensional (3D) profile as the sleeves unitary body 815. The polymer forming the outer body is then injected under high temperature and pressure into the mold. Once the over molded body is formed and allowed to set, the mold is opened and the tubular body 810 with the in situ molded reinforced wear sleeve is removed from the injection molding machine.

In another embodiment a discrete length of tubular body 810 may have one or more reinforced wear sleeves (combination of the sleeve and wear cage) (not shown) molded along its length.

When the reinforced wear sleeve is fitted to the drilling tubular and run downhole, the initial wear is on the outer surface of the cylindrical body. Once the outer circumference of the cylindrical body is worn, the outer surface of the annular elements 925 will be exposed and in contact with the bore of the casing. The wear will now be taken up by both the remaining exposed outer surface of the cylindrical body and by the outer surface of the annular elements 925 of the wear resisting cage 805.

The wear resisting cage 805 material with its improved hardness properties and composition provides greater abrasion resistance that the material of the surrounding body.

An improved method for applying an RFID tag to tubular components used in drilling, pipeline, and hydraulic fracturing applications; that does not embed or compromise the tubular body; the process comprises of applying an RFID tag to the tubular body and protecting the tag through the method of injection molding of a polymer around the RFID tag and the tubular body. The tubular sleeve is cylindrical and may or may not have integrally formed grooves run helically along its length. A high performance polyurea coating is added to the outer surface of the fiber reinforced polymer to aid in the extended life of the tubular sleeve; this polyurea shall consist of 100% solids and 100% polyurea.

A wear resistant downhole tubular sleeve may include a cylindrical body injection molded onto and around the tubular body of tubular components used in drilling, pipeline, and hydraulic fracturing with integral grooves running angularly along the axis of the body and an outer wear resistant surface applied as a spray coating forming an integrally bonded outer layer of greater hardness than the base material of the pre-formed body and an RFID tag or multiple RFID tags are embedded into the body of the tubular sleeve and in contact with the tubular components used in drilling, pipeline, and hydraulic fracturing applications.

More particularly, used in tubulars and tools with a variety of dimensions, wall thicknesses and cross-sectional area; where little to no cross-sectional area is available.

A method of embedding one or more RFID tags into the tubular sleeve as described above allowing data to be written to and read from the tag or tags. A method of repairing worn or damaged downhole tubular sleeve with spray application of the spray polyurea as described above. The polymer described above may be a single polymer type, a combination of polymers types, a polymer or a combination of polymers with a reinforcing material. A plurality of integral grooves running angularly along the length of the downhole tubular sleeve as described above. An external wear surface applied by spray comprising a multi component polyurethane polymer.

A method of applying an external wear surface applied by spraying a multi component polyurethane polymer to a base material. An RFID tag is placed on a tubular. The RFID tag will include a light adhesive on the surface that is in contact with the tubular. This adhesive keeps the RFID tag attached to the tubular as the tubular is placed on a rack and fed through the injection molder. The tubular is positioned so that the injection mold will encircle the tubular where the RFID tag is located. The injection molder closes around the tubular where the RFID tag is positioned. A polymer is then injected into the mold which forms around the tubular where the RFID tag is positioned. The polymer is allowed to cool and cure on the tubular where the RFID tag is positioned resulting in a sleeve with an RFID tag.

An RFID tag is placed on a tubular and a piece of tape placed on top to hold it in place. The piece of tape keeps the RFID tag attached to the tubular as the tubular is placed on a rack and fed through the injection molder. The tubular is positioned so that the injection mold will encircle the tubular where the RFID tag is located. The injection mold closes around the tubular where the RFID tag is positioned. A polymer is then injected into the mold which forms around the tubular where the RFID tag is positioned. The polymer is allowed to cool and cure on the tubular where the RFID tag is positioned resulting in a sleeve with an RFID tag.

An RFID tag is placed on a tubular. The RFID tag is then wrapped with 3M Scotchcast Plus Casting Tape. The 3M Scotchcast Plus Casting tape is applied wet and wrapped around the tubular where the RFID tag is located. As it dries, the 3M Scotchcast Plus Casting tape hardens to form a protective coating around the RFID tag.

A method for applying one or more self contained sensor assembly for measurement of but not limited to acceleration, strain, temperature and GPS location to tubular components used in drilling, pipeline, and hydraulic fracturing applications; that does not embed or compromise the tubular body; the process comprises of applying a sensor assembly to the tubular body and protecting the sensor assembly through the method of injection molding around the sensor assembly and the tubular body. The tubular sleeve is cylindrical and may or may not have integrally formed grooves running helically along its length. A high performance polyurea coating is added to the outer surface of the fiber reinforced polymer to aid in the extended life of the tubular sleeve; this polyurea shall consist of 100% solids and 100% polyurea.

A method of embedding one or more sensor assemblies into the tubular sleeve as described above allowing the sensor assembly or assemblies to be pre-configured and data to be recorded by the sensor assembly or assemblies and read from each of the sensor assemblies.

A method of applying and embedding a solid particle material to the external polymer surface during or following the polymer spray application to aid in extending the life of the tubular sleeve. This particle is preferably tungsten carbide in the range of 2 to 3 mm in diameter and spherical in shape but can be other materials with similar properties, and size and shape may vary to suit the application.

An improved wear sleeve used for well and pipe line construction comprising a rigid fiber reinforced polymer wear resisting cage encapsulated in an outer tubular fiber reinforced polymer sleeve over-molded in-situ by an injection molding process where the rigid fiber reinforced wear resisting cage aids in extending the life of the wear sleeve.

A wear resisting cage assembly may include two symmetrical halves of a fiber reinforced polymer cage that are pre-molded and placed over the outer circumference of a tubular and assembled into position for each wear resisting cage half assembly, multiple annular solid half shell sections elements joined with one or more webs for each wear resisting cage half assembly, multiple annular solid half shell sections elements with an integral channel along the full circumferential length of the inner surface together with one or more channels running perpendicular to the channel running the full circumferential length.

A wear resisting cage as described above where integrals channels provided for the flow of polymer during an injection over molding process. A wear resisting cage assembly as described above, preferably injection molded from a polyamide with glass fiber reinforcing. A wear resisting cage assembly as described above that is formed from a ceramic material. A wear resisting cage assembly as described above, injection molded preferably from a polyamide 66 with 65% glass fiber reinforcing.

A wear resisting band as described as described above that may be molded from a colored base polymer. A wear resisting cage assembly as described above where the assembly is placed around the outer circumference of a section of the tubular and injection over molded to encapsulate the wear resisting cage fully. The placement of one or more wear sleeves as described above on a tubular.

An over molded outer sleeve as described above where the polymer material is a polyamide and with the addition of a glass, carbon or mineral fiber reinforcing.

A drill pipe protector may include a cylindrical body directly injection molded onto and around the body of a drill pipe with integral raised stop collars at each end tapering off towards the drill pipe body; and a cylindrical outer sleeve having an outside diameter greater than that of the drill pipe tool joint, directly molded over the cylindrical form leaving clearance between this sleeve and the inner body allowing the inner body and drill pipe to freely rotate and; the cylindrical outer sleeve with or without a plurality of raised flat ridges extending helically the length of the sleeve and in the sections of outer sleeve between the raised ridges, a plurality of formed holes in each section.

A method of making a drill pipe protector may include the steps of directly placing a mold set over the drill pipe body and injection molding onto a drill pipe a cylindrical body with integral raised stop collars at each end and then placing a mold set over the pre-formed body and injection molding an outer cylindrical sleeve with a plurality of raised ridges running at a helical angle the length of the outer sleeve with a plurality of formed holes in the sections between the ridges leaving clearance between the outer sleeve and inner body.

A method of forming the clearance between the outer sleeve and inner cylindrical body may include firstly pre-forming the cylindrical body with integral stop collars then wrapping one or more full wraps of a soluble sheet material around the body between the stop collars and securing in place then placing a mold set over this layer of material and inner body and injection molding a polymer of differing hardness and or friction coefficient directly onto and around the wrapping material forming a unitary sleeve.

A method of removing the soluble sheet material from between the inner and outer sleeve leaving a clearance space between may include placing the drill pipe with its protector or multiple protectors onto a supporting carriage, placing a stationary tool that matches the form of the drill pipe protector over the outer sleeve fully surrounding it. The tool completes with integral air and water channels, high pressure water hot, cold or steam together with or without compresses air is applied independently through the tool and into selected pre-formed holes in the outer sleeve while the drill pipe is rotated in one or other direction or alternating between the two.

Either water, steam and compresses air or a combination thereof is used to remove the soluble sheet material.

A tool matching the profile of the outer sleeve is placed over the sleeve fully surrounding it and with integral water and air channels extending through to the pre-formed holes in the sleeve.

Integral raised stop collars are molded together with the sleeve forming a unitary body and sized to fit the appropriate drill pipe diameter. The integral raised stop collars retain the outer sleeve to the inner body restricting lateral travel of the outer sleeve.

The clearance is formed between the outer surface of the inner body and inner surface of the outer sleeve and together with the pre-formed holes in the sections between the raised ridges of the outer sleeve allowing the flow of drilling fluid in the clearance space creating a fluid bearing.

### Drill Pipe Protector

A drill pipe protector in the form of a cylindrical sleeve is directly molded onto the drill pipe forming a continuous smooth cylindrical surface with a raised stop collar at each end of the cylindrical form. This cylindrical sleeve is formed directly onto the drill pipe surface surrounding it forming a unitary body gripping the pipe rigidly. A wrap or multiple wraps of a removable material is inserted around the circumference of the cylindrical form to a desired thickness between the stop collars, and an outer continuous profiled cylindrical sleeve is directly injection molded over the wrapping. The outer cylindrical sleeve, with a plurality of helical ridges running along its length forms a unitary sleeve surrounding the outer surface of the wrapping and inner sleeve. A plurality of holes is formed as part of the molding process in the sections between the raised ridges of the outer sleeve.

The wrapping material may be subsequently removed, allowing the inner body and drill pipe to rotate within the outer sleeve that forms the bearing surface with drilling fluid acting as the lubricant when the drill pipe is in use.

During the drilling process once the raised helical ridge of the outer sleeve comes into contact with the well formation, its rotation speed will be reduced or remain stationary allowing the inner sleeve together with the drill pipe to continue to rotate within a fluid bearing.

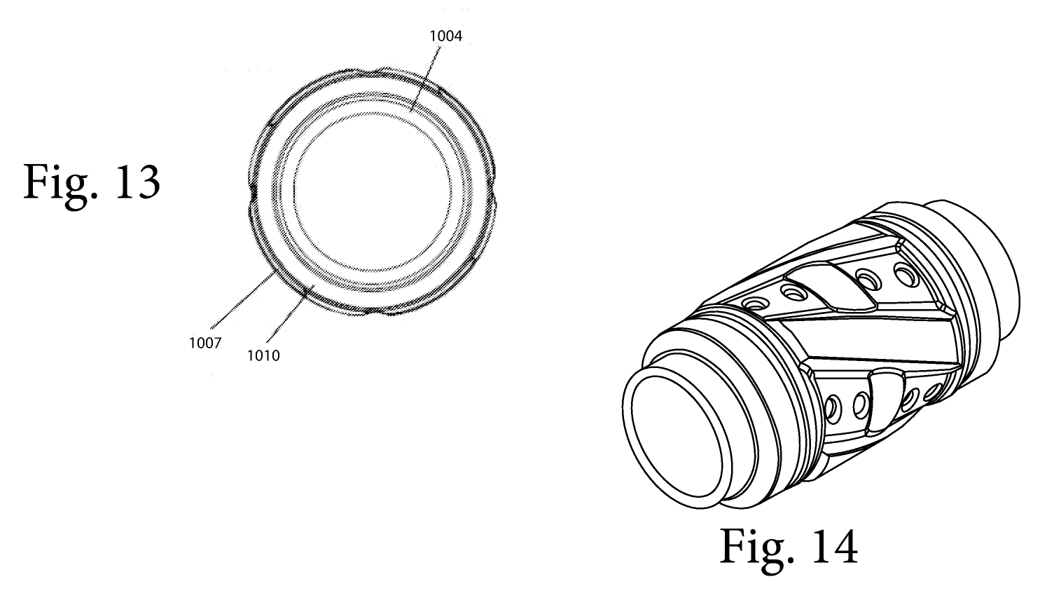

The drill pipe protector is shown in FIGS. 10-14. An inner sleeve 1004 may be directly injection molded to a drill pipe 1001 forming a unitary body with integral stop collars 1002 and 1003. The stop collars 1002 and 1003 may be tapered at each end 1010 so as to allow the stop collars 1002 and 1003 to ride over any obstructions in the wellbore.

An outer sleeve 1007 may have a unitary sleeve that may be formed by directly injection molding over the inner sleeve 1004. This method may be accomplished by wrapping one or more wraps of a soluble sheet material 1014 around the inner sleeve 1004 and between the stop collars 1002 and 1003, leaving sufficient clearance space 1015 between the edge of the wrap and stop collars 2 and 3 for the mold to seal. The soluble sheet material 1014 may include a variety of soluble materials, which may include, for example, soluble paper or Plantic HP1. The soluble sheet material 1014 may be provided in sheets rolled into rolls and may be provided in standard lengths or widths defined by the manufacturer or in custom lengths and widths. The width of the soluble sheet material 1014 may vary in size depending on its application. The width of the soluble sheet material 1014 may depend on the length of the inner sleeve 1004. The width of the soluble sheet material 1014 may be 227 (millimeters) mm. The thickness of the soluble sheet material 1014 may vary depending upon the application, the environment, and the clearance needed between the inner sleeve 1004 and the outer sleeve 1007. The thickness of the soluble sheet material 1014 may be 0.2 mm. A space between the inner sleeve 1004 and the outer sleeve 1007 may be measured by the thickness of the soluble sheet material 1014. The thickness of the soluble sheet material 1014 may be chosen to allow drilling fluid to flow between inner sleeve 104 and outer sleeve 1007, while restricting cuttings from the drilling to enter the space 1015 or the space between the inner sleeve 1004 and outer sleeve 1007 left when the soluble sheet material 1014 is removed, as described below. The thickness of the soluble sheet material 1014 may be selected to provide a space between the inner sleeve 1004 and the outer sleeve 1007 of 0.4 mm. The soluble sheet material 1014 may be cut to length and width to satisfy the width and thickness requirements for a particular application. The soluble sheet material 1014 may be secured in a variety of ways, which may include wrapping the soluble sheet material 1014 around the inner sleeve 1004 and taping the soluble sheet material 1014 together. The soluble sheet material 1014 may be wrapped in two full wraps before it is secured.

The inner sleeve 1004 is molded as a single unitary body with a mold comprising two mold halves with each half comprising two individual mold pieces, where each piece represents a quarter of the complete mold. Each mold piece is pivoted at the sides and free to pivot a pre-determined amount when opened and closed. When the mold pieces are clamped together around the drill pipe 1001 the mold pieces close around the drill pipe 1001 surrounding it. Flexible seals at each end of the mold pieces seal the ends of the mold taking up any small variances in the drill pipe 1001 diameter preventing leakage of polymer material. A polymer material is injected in through an opening in the mold and held under pressure for a fixed time before the mold is opened. Suitable polymer material includes, but is not limited to, a thermoplastic polymer, for example a polyamide with or without fiber reinforcing. Such fiber reinforcing may include but not limited to glass, carbon, mineral or other synthetic fiber.

The outer sleeve 1007 is molded as a unitary sleeve with a mold comprising two mold halves with each half comprising two individual mold pieces, where each piece represents a quarter of the complete mold. Each mold piece is pivoted at the sides and free to rotate a predetermined amount when open. When the mold pieces are clamped together around the inner body with the applied wrapping, the mold pieces close around and surround the inner sleeve 1004. Flexible seals at each end of the mold pieces seal the ends of the mold. A polymer material is injected in through an opening in the mold and held under pressure for a fixed time before the mold is opened. Suitable polymer material includes but not limited to a thermoplastic polymer of differing hardness and friction coefficient to the inner body. For example a polyamide with or without fiber reinforcing. Such fiber reinforcing may include but not limited to glass, carbon, mineral or other synthetic fiber. Additional additives may be used to modify the friction coefficient.

The outer sleeve 1007 has a plurality of integral raised ridges 1006 running at a helical angle the length of the outer sleeve 1007 and the effective overall outer diameter of the raised ridges 1006 is greater than that of the outer diameter of the stop collars 1002 and 1003. The outer diameter of the raised ridges 1006 is also greater than the outer diameter of the drill pipe 1001 tool joint. The raised ridges 1006 have tapers 1016 at either end to allow it to ride over any obstructions in the well. A rib 1009 is integrally molded between each raised ridge 1006 and spans the section between the raised ridges 1008. A plurality of holes 1005 is formed by the mold between the raised ridges 1006. The clearance space 1015 allows the outer sleeve 1007 to move a limited distance between the two stop collars 1002 and 1003 and, with the holes 1005 and space 1015, allows the flow of drilling fluid to act as the lubricant between the inner sleeve 1004 and outer sleeve 1007 when drilling. Additionally, the plurality of holes 1005 allows the flow of water and air in the removal of the soluble sheet material 1014 after the forming of the outer sleeve 1007. The number of raised ridges 1006, their width and helical angle may vary according to the particular application. FIG. 10 is a plan illustration showing one embodiment.

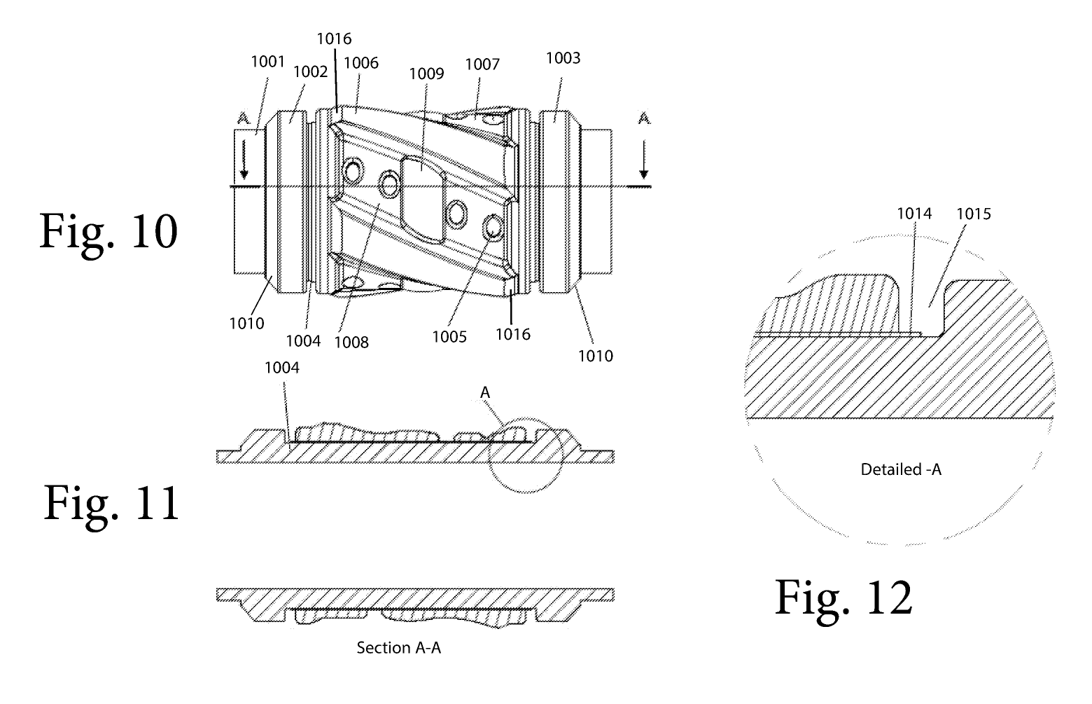

The soluble sheet material 1014 shown in FIG. 12 is removed as described in the following method. The drill pipe 1001 with one or more protectors is placed onto a supporting carriage allowing the drill pipe 1 to rotate in position. A drive system attaches to the tool joint end which rotates the drill pipe 1001 along its axis in either direction and at a constant speed that can be adjusted as required to suit the application.

A tool (not shown) is attached to the drill pipe protector in the horizontal position. The tool clamps to both the top and bottom sections of the outer sleeve 1007 along its full length. The tool has the same profile as that portion of the outer sleeve 1007. The tool is preferably made from a metal or alloy, has integral internal preformed water and air channels positioned to open out directly over selected preformed holes 1005 in the inner sleeve 1004. The tool together with the outer sleeve 1007 is held in place to remain stationary relative to the drill pipe 1001 while the inner body together with the drill pipe 1001 rotates.

A system which supplies water heated as required and/or generates steam under pressure is connected to the tool, the flow being adjustable. Compressed air with adjustable pressure is supplied to the tool at the same time.

The drill pipe 1001 is rotated while the pressurized water is applied to the tool either with or without the compressed air. The direction of rotation of the drill pipe 1001 may be varied during the process. The pressurized water in combination with compressed air, if used, is applied through a number of the pre-formed holes 1005 enabling the soluble sheet material 1014 to be washed out and ejected out through the exposed holes 1005. This process leaves the space between the inner sleeve 1004 and the outer sleeve 1007 when the soluble sheet material 1014 is washed away, and the clearance space 1015 between the stop collar 1002 and 1003 and outer sleeve 1007.

When the soluble sheet material 1014 is removed, clearance is formed between the inner sleeve 1004 and outer sleeve 1007 allowing the drill pipe 1001 to rotate relative to the stationary outer sleeve 1007.

Multiple drill pipe protectors may be molded onto a single drill pipe 1001 and a multiple number of tools may be set up to remove the soluble sheet material 1014 at the same time.

In its application during the drilling process once the raised ridge 1006 of the outer sleeve 1007 comes into contact with the well formation, and under the side load exerted by the drill string, the rotation speed of the outer sleeve 1007 will be reduced or remain stationary allowing the inner sleeve 1004 together with the drill pipe 1001 to continue to rotate effectively with a fluid bearing. This results in significantly reduced wear as the outer surface of the protector is no longer driven at the same speed as the drill string when in contact with the wall of the wellbore in open hole. This also results in reduced drag when drilling in the well formation. The drill pipe 1001 body is not the bearing surface reducing the potential for damage or wear to the drill pipe 1001 itself.

A drill pipe protector may include a cylindrical body directly injection molded onto and around the body of a drill pipe with integral raised stop collars at each end tapering off towards the drill pipe body and a cylindrical outer sleeve having an outside diameter greater than that of the drill pipe tool joint, directly molded over the cylindrical form leaving clearance between this sleeve and the inner body allowing the inner body and drill pipe to freely rotate and the cylindrical outer sleeve with or without a plurality of raised flat ridges extending helically the length of the sleeve and in the sections of outer sleeve between the raised ridges, a plurality of formed holes in each section.

A method of making a drill pipe protector may include the steps of directly placing a mold set over the drill pipe body and injection molding onto a drill pipe a cylindrical body with integral raised stop collars at each end and then placing a mold set over the pre-formed body and injection molding an outer cylindrical sleeve with a plurality of raised ridges running at a helical angle the length of the outer sleeve with a plurality of formed holes in the sections between the ridges leaving clearance between the outer sleeve and inner body.

A method of forming the clearance between the outer sleeve and inner cylindrical body may include firstly pre-forming the cylindrical body with integral stop collars then wrapping one or more full wraps of a soluble sheet material around the body between the stop collars and securing in place then placing a mold set over this layer of material and inner body and injection molding a polymer of differing hardness and or friction coefficient directly onto and around the wrapping material forming a unitary sleeve.

A method of removing the soluble sheet material from between the inner and outer sleeve leaving a clearance space between may include placing the drill pipe with its protector or multiple protectors onto a supporting carriage, placing a stationary tool that matches the form of the drill pipe protector over the outer sleeve fully surrounding it. The tool completes with integral air and water channels, high pressure water hot, cold or steam together with or without compresses air is applied independently through the tool and into selected pre-formed holes in the outer sleeve while the drill pipe is rotated in one or other direction or alternating between the two.

Either water, steam and compresses air or a combination thereof is used to remove the soluble sheet material.

A tool matching the profile of the outer sleeve may be placed over the sleeve fully surrounding it and with integral water and air channels extending through to the pre-formed holes in the sleeve.

Integral raised stop collars may be molded together with the sleeve forming a unitary body and sized to fit the appropriate drill pipe diameter.

The integral raised stop collars may retain the outer sleeve to the inner body restricting lateral travel of the outer sleeve.

The clearance may be formed between the outer surface of the inner body and inner surface of the outer sleeve and together with the pre-formed holes in the sections between the raised ridges of the outer sleeve allowing the flow of drilling fluid in the clearance space creating a fluid bearing.

Therefore, the present disclosure is well adapted to attain the ends mentioned as well as those that are inherent therein. The particular embodiments disclosed above are illustrative only, as the present disclosure may be modified and practiced in different but equivalent manners apparent to those skilled in the art having the benefit of the teachings herein. Even though the figures depict embodiments of the present disclosure in a particular orientation, it should be understood by those skilled in the art that embodiments of the present disclosure are well suited for use in a variety of orientations. Accordingly, it should be understood by those skilled in the art that the use of directional terms such as above, below, upper, lower, upward, downward and the like are used in relation to the illustrative embodiments as they are depicted in the figures, the upward direction being toward the top of the corresponding figure and the downward direction being toward the bottom of the corresponding figure.

Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that the particular article introduces; and subsequent use of the definite article “the” is not intended to negate that meaning.

In one aspect, a method features coupling a tag to a sleeve and coupling the sleeve to a tubular body.

Implementations may include one or more of the following. The tag may include an RFID tag. The tag may include a sensor device. The tag may be embedded to the sleeve during injection molding. Worn areas of the sleeve may be repaired with a polymer spray.

In one aspect, a method features coupling a tag to a tubular body and encapsulating the tag and tubular body with a sleeve.

Implementations may include one or more of the following. The tag may include an RFID tag. The tag may include a sensor device. Encapsulating the tag and tubular body with a sleeve may include applying a polymer coating and embedding a solid particle material in a surface of the polymer coating.

Integral grooves may be formed into the sleeve traversing the sleeve in a spiral pattern. Encapsulating the tag and tubular body with a sleeve may include coupling the tag to the tubular body during an injection molding process and applying a polymer coating using a spray application process. Encapsulating the tag and tubular body with a sleeve may include wrapping the tag onto the tubular body with urethane impregnated fiberglass tape activated by water.

In one aspect, a method features coupling a tag to a tubular. A wear cage is coupled over the tag onto the tubular. The wear cage is over molded with a polymer material.

Implementations may include one or more of the following. Over molding the wear cage with polymer material may include the polymer material flowing through a circumferential integral channel in one of a plurality of annular elements in the wear cage. Over molding the wear cage with polymer material may include the polymer material flowing through a channel that intersects the circumferential integral channel.

In one aspect, an apparatus features a sleeve. The tag is embedded into the sleeve during injection molding.

Implementations may include one or more of the following. The sleeve may include an outer wear resistant surface having a plurality of integral grooves traversing angularly along the outer wear resistant surface. The sleeve may include a polyurethane polymer coating. The sleeve may be embedded with tungsten carbide.

In one aspect, an apparatus features a wear resisting cage having a plurality of annular elements. The plurality of annular elements has a circular integral channel along an inside circumferential diameter of the annular element and a channel intersecting the circular integral channel. The apparatus has a plurality of stand-offs holding apart the plurality of annular elements.

Implementations may include one or more of the following. Each of the plurality of annular elements may be split in half into two wear resisting cage halves. The two wear restricting cage halves may be couplable via interference-fitting dowels. The plurality of annular elements and stand-offs may be constructed from a fiber-reinforced polymer. The wear resisting cage may be encapsulated in a polymer during an injection molding process

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An improved method for applying one or more tags to a tubular component used in drilling, pipeline and hydraulic fracturing applications, the tubular component comprising a tubular body, the method comprising:
placing the one or more tags on the tubular body;
holding the one or more tags in place without embedding the one or more tags into or compromising the tubular body; and
protecting the one or more tags by injection molding of a fiber reinforced polymer material around the one or more tags and the tubular body.

2. The method of claim 1 wherein the tag comprises an RFID tag.

3. The method of claim 1 wherein the tag comprises a sensor device.

4. The method of claim 1, wherein holding the one or more tags in place comprises applying an adhesive to a surface of the tag that is in contact with the tubular body, or placing a piece of tape over the tag to keep the tag attached to the tubular body.

5. The method of claim 1, wherein the injection molding results in one or more sleeves being formed around the one or more tags and the tubular body.

6. The method of claim 4 wherein the one or more sleeves each has one or more tags embedded therein.

7. The method of claim 5 further comprising applying a polymer coating to substantially cover an external surface of one or more sleeves.

8. The method of claim 7 wherein the polymer coating has a greater hardness than the fiber reinforced polymer material forming the sleeve.

9. The method of claim 7 wherein the polymer coating is applied using a spray application process.

10. The method of claim 9 further comprising repairing worn areas of the polymer coating with a polymer spray.

11. The method of claim 7 further comprising embedding a solid particle material in a surface of the polymer coating.

12. The method of claim 1 wherein the fiber reinforced polymer material is a polymer material reinforced with a synthetic fiber.

13. The method of claim 12 wherein the synthetic fiber is selected from the group consisting of glass fiber, carbon fiber, aramid fiber, mineral fiber and combinations thereof.

14. An improved method for applying a tag to a tubular component used in drilling, pipeline and hydraulic fracturing applications, the tubular component comprising a tubular body, the method comprising:
coupling a tag to a tubular body without embedding the tag into or compromising the tubular body; and
encapsulating the tag and tubular body with a sleeve formed from a fiber reinforced polymer material around the tag and the tubular body.

15. The method of claim 14 wherein the tag comprises an RFID tag.

16. The method of claim 14 wherein the tag comprises a sensor device.

17. The method of claim 14, wherein coupling a tag to a tubular body comprises applying an adhesive to a surface of the tag that is in contact with the tubular body, or placing a piece of tape over the tag to keep the tag attached to the tubular body.

18. The method of claim 13 further comprising:
forming integral grooves into the sleeve traversing the sleeve in a spiral pattern.

19. The method of claim 14 wherein encapsulating the tag and tubular body with a sleeve further comprises:
applying a polymer coating to an outer surface of the sleeve using a spray application process.

20. The method of claim 19 further comprising embedding a solid particle material in a surface of the polymer coating.

21. An improved method for applying a tag to a tubular component used in drilling, pipeline and hydraulic fracturing applications, the tubular component comprising a tubular body, the method comprising:
coupling a tag to a tubular body without embedding the tag into or compromising the tubular body; and
encapsulating the tag and tubular body with a sleeve by wrapping the tag and the tubular body with urethane impregnated fiberglass tape activated by water.

22. An improved method for applying a tag to a tubular component used in drilling, pipeline and hydraulic fracturing applications, the tubular component comprising a tubular body, the method comprising:
coupling the tag to the tubular body;
coupling a wear cage, formed from injection molding of an optionally reinforced polymer material, over the tag onto the tubular body; and
over molding the wear cage with a fiber reinforced polymer material, to thereby form a reinforced wear sleeve for protecting the tag and the tubular body.

23. The method of claim 22 wherein over molding the wear cage with polymer material comprises:
the polymer material flowing through a circumferential integral channel in one of a plurality of annular elements in the wear cage.

24. The method of claim 22 wherein over molding the wear cage with polymer material further comprises:
the polymer material flowing through a channel that intersects the circumferential integral channel.

25. An apparatus for applying to a tubular component used in drilling, pipeline and hydraulic fracturing applications, the apparatus comprising:
a sleeve formed from injection molding of a fiber reinforced polymer material, and
one or more tags embedded into the sleeve during injection molding;
wherein the sleeve has an external diameter smaller or bigger than an external diameter of a tool joint of the tubular component.

26. The apparatus of claim 25 wherein the sleeve comprises:
an outer wear resistant surface comprising a plurality of integral grooves traversing angularly along the outer wear resistant surface.

27. The apparatus of claim 26 wherein the sleeve comprises an outer layer of polyurethane polymer coating.

28. The apparatus of claim 27 wherein the out layer of the sleeve is embedded with tungsten carbide.

29. An apparatus for placing over one or more tags applied to a tubular component used in drilling, pipeline and hydraulic fracturing applications, the apparatus comprising:
a wear resisting cage comprising a plurality of annular elements, wherein
each of the plurality of annular elements comprises a circular integral channel along an inside circumferential diameter of the annular element and a channel intersecting the circular integral channel, and
a plurality of stand-offs holding apart the plurality of annular elements, thereby creating a plurality of openings to be positioned over the one or more tags;
wherein the apparatus forms part of a wear sleeve and aids in extending the life of the wear sleeve for protecting the one or more tags and the tubular component.

30. The apparatus of claim 29 wherein each of the plurality of annular elements is split in half into two wear resisting cage halves.

31. The apparatus of claim 30 wherein the two wear resisting cage halves are couplable via interference-fitting dowels.

32. The apparatus of claim 29 wherein the plurality of annular elements and stand-offs are constructed from a fiber-reinforced polymer.

33. The apparatus of claim 29 wherein the wear resisting cage is encapsulated in a polymer during an injection molding process.
